(19) United States
(12) Patent Application Publication
(10) Pub. No.: US 2015/0360825 A1
(43) Pub. Date: Dec. 17, 2015

(54) Container with a Detachable Funnel

(71) Applicant: David Phillip Susca, Raleigh, NC (US)

(72) Inventor: David Phillip Susca, Raleigh, NC (US)

(21) Appl. No.: 14/735,479

(22) Filed: Jun. 10, 2015

Related U.S. Application Data
(60) Provisional application No. 62/011,355, filed on Jun. 12, 2014.

(51) Int. Cl. B65D 35/24; B65D 1/02; B65B 51/10; B67C 11/02; B65B 3/04

(52) U.S. Cl. CPC B65D 35/24; B67C 11/02; B65B 3/045; B65B 51/10; B65D 1/023

(57) ABSTRACT

A disposable container is formed as a unitary structure, and has a flexible body that defines reservoir to store a product, a funnel detachably connected to the flexible body to introduce the product into the reservoir, and a heat-sensitive neck section detachably connecting the funnel to the flexible body. The heat-sensitive neck section defines a channel through which the product passes from the funnel into the reservoir, and may be heat-sealed at multiple locations to seal and reseal the product within the reservoir.

### RELATED APPLICATIONS

This application claims priority from U.S. Provisional Patent Application Ser. No. 62/011,355 filed Jun. 12, 2014, the entire contents of which are incorporated herein by reference.

### FIELD OF THE INVENTION

The present disclosure relates generally to disposable containers, and more particularly, to disposable containers that are flexible and have detachable funnels.

### BACKGROUND

Containers, such as jars, bottles, cans, pouches, and flasks, for example, are very useful for storing and transporting a variety of different fluid, semi-fluid, and solid substances. Generally, containers are filled with a product through a relatively small opening in the top of the container. Of course, automated filling systems can fill such containers through these openings quickly and easily. However, individuals do not normally have access to such machinery and automated filling systems. Thus, for some people, filling containers with a substance can be problematic and awkward.

Historically, people have used funnels to help them fill containers with a substance. However, funnels are not always readily available when needed. Therefore, many people will have to find or purchase a funnel before they can fill a container. Even when they are available, however, it is difficult to find a funnel that is properly sized for the relatively small opening of a given container. For example, many funnels are too large for the openings of certain types of containers such as pouches and flasks. Further, because funnels are distinct devices that are separate from the containers, their use in filling containers can be awkward. In some cases, users must hold and stabilize the funnel and the container being filled, as well as the vessel that contains the substance being poured into the container. Additionally, the size and shape of a funnel makes it awkward to transport with the containers.

### SUMMARY

The present disclosure provides a flat container, such as a flask or pouch, for example, having a funnel. The container and the funnel are provided as a unitary structure. The funnel allows a user to quickly and easily fill the container with a product that is in one of a liquid state, a solid state, or an oxciouses state. Once filled, the user can seal the container to seal product in the container. To open the container and remove the product stored therein, the user simply detaches the funnel from the container below the seal. The container may thereafter be resealed by the user to reseal any unused portion of the product in the container.

Accordingly, one aspect of the present disclosure provides a method of filling a flexible unitary container with a product. The container comprises a flexible body that stores the product in a reservoir, and is formed by heat-sealing opposing flat sheets of material along a peripheral edge. A funnel is detachably connected to the flexible body, and is configured to introduce the product into the reservoir. A heat-sensitive neck section detachably connects the funnel to the flexible body, and defines a channel through which the product passes from the funnel into the reservoir. Once filled, the product is sealed within the reservoir by applying heat to the heat-sensitive neck section, and the funnel may be detached from the flexible body.

According to another aspect, the container comprises first and second flat flexible sheets sealed at their peripheral edges. The sealed sheets form a reservoir to store a product, a detachable funnel, a channel communicatively connecting the funnel to the reservoir, and a heat-sensitive neck section disposed between the detachable funnel and the reservoir. The heat-sealing neck section is configured to be heat-sealed to seal the product within the reservoir.

In another aspect, the container is a unitary structure comprised of opposing flat sheets of a heat-sensitive material sealed at a peripheral edge. When sealed, the container has a flexible body that defines a reservoir to store a product, a funnel detachably connected to the flexible body and configured to introduce the product into the reservoir, and a heat-sensitive neck section detachably connecting the funnel to the flexible body. The heat-sensitive neck section defines a channel through which the product passes from the funnel into the reservoir, and is configured to be heat-sealed at multiple locations to seal and reseal the product within the reservoir.

Of course, those skilled in the art will appreciate that the present invention is not limited to the above contexts or examples, and will recognize additional features and advantages upon reading the following detailed description and upon viewing the accompanying drawings.

### BRIEF DESCRIPTION OF THE DRAWINGS

FIGS. 1A-1B are perspective views of a container having a detachable funnel configured according to one embodiment of the present disclosure.

FIG. 2 is a perspective view of a container with a detachable funnel according to another embodiment of the present disclosure.

FIG. 3 is a perspective view of a container with a detachable funnel according to another embodiment of the present disclosure.

FIG. 4 is a perspective view of a container with a detachable funnel according to another embodiment of the present disclosure.

FIG. 5 is a perspective view of a container with a detachable funnel according to another embodiment of the present disclosure.

FIG. 6 is a perspective view of a container with a detachable funnel according to another embodiment of the present disclosure.

### DETAILED DESCRIPTION

Embodiments of the present disclosure provide a flexible, resealable container, such as a pouch or a flask, for example, that stores products for use and transport. The products may be, by way of example only, liquids having various levels of viscosity (e.g., water, wine, shampoo, hair gels, etc.), solids (e.g., snack foods, candies, etc.), and products that have properties of both solids and liquids (e.g., products in an oxciouses state such as applesauce). The container is flexible and collapsible so that a user may easily store and transport the container, but in at least some embodiments, is configured to be able to stand on its own. Additionally, in some embodiments, the container may be coated with, or produced from, a substance or material configured to protect the product within the container from the harmful effects of ultraviolet (UV) rays.

In one embodiment, the container comprises a detachable funnel that facilitates filling the container. Once filled, the user may heat-seal the container to seal the product in the container. The seal is generally air-tight to prevent the container from leaking and to protect the product within the container from spoiling. Thereafter, to open or unseal the container, the user detaches the funnel from the container at a location that is below the seal. Once detached, the user may empty the product from the container. However, the user need not empty the container of all the product. In some cases, for example, the user may not wish to consume all of the product in the container, but instead, save some of the product for later. In other cases, the user may wish to wash or clean the container and re-fill the container with the same or a different product. In either case, the user may reseal the container even after the funnel has been removed and/or the container has been opened. As for the detachable funnel, the user may utilize the funnel for other applications, reattach the funnel to the container to facilitate re-filling the container, or simply discard the funnel.

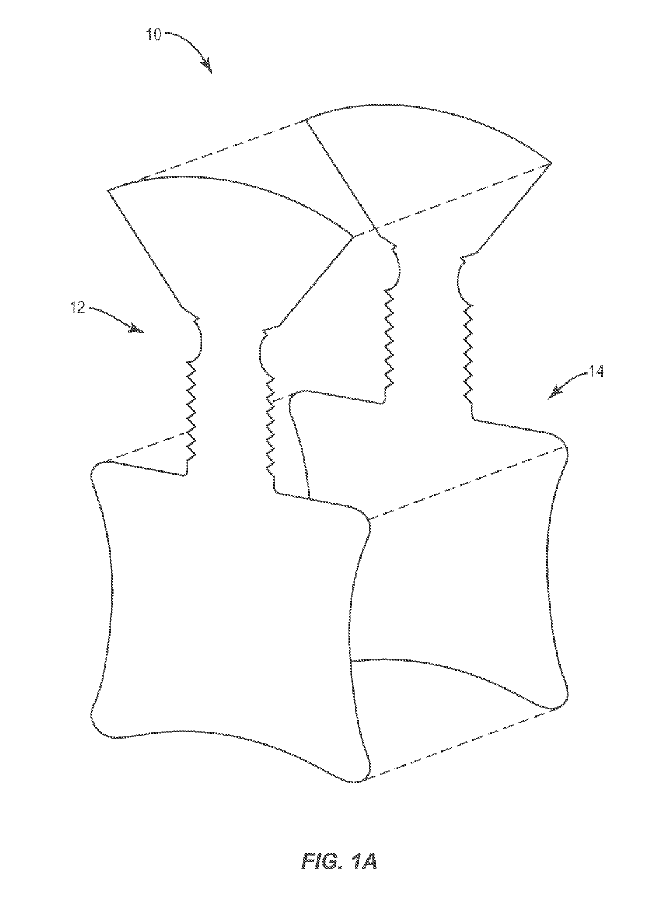

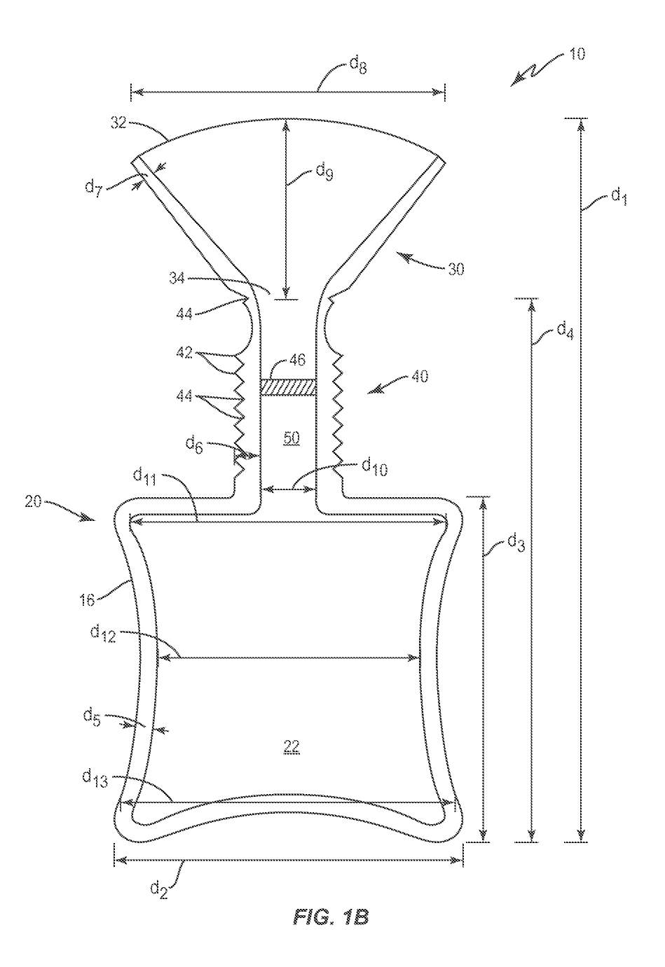

Turning now to the drawings, FIGS. 1A-1B illustrate a perspective view of a flexible container 10 according to one embodiment of the present disclosure. As seen in FIG. 1A, container 10 comprises generally flat first and second sheets 12, 14 constructed of a material, such as plastic. Generally, the material is thin, heat-sensitive, and flexible so that container 10 is capable of deforming easily without breaking. Additionally, however, the material used for sheets 12, 14 is also suitable for the intended use of container 10. For example, in some embodiments, container 10 will be used to store and transport products that are intended for human consumption (e.g., food or drink). In these embodiments, sheets 12, 14 may be made from a food-grade plastic such as Polyethylene terephthalate (PET) or High Density Polyethylene (HPD), or other material that is suitable for contacting products that will be ingested by humans or animals. In other cases, however, container 10 may be used to store and transport products that are not intended to be ingested by humans or animals, such as shampoo, conditioner, or hair gel. In these cases, the plastic used for sheets 12, 14 need not be food-grade plastic, but rather, may be any plastic or material known in the art suitable for storing such products.

To form the container 10, the sheets 12, 14 are placed together and then bound at their respective edges using heat. For example, in one embodiment, a heat-sealing device or tool may be used to apply heat within a predetermined temperature range (e.g., 90° C. to about 270° C.) to the edges of sheets 12, 14. The heat-sealing tool used may be any heat-sealer known in the art. Such tools include, but are not limited to, heat bar sealers, impulse heat sealers, and continuous or “band type” heat sealers. The heat from the tool binds the edges of sheets 12, 14 together and forms the peripheral edge 16 that prevents a product stored within container 10 from leaking.

Those of ordinary skill in the art will readily appreciate that heat-sealing is not the only means by which to bind the edges of flexible sheets 12, 14 together to form peripheral edge 16. Rather, any known method may be employed to join and seal the first and second sheets 12, 14 at their respective peripheral edges.

Regardless of the particular method used to seal the edges, the container 10, as seen in FIG. 1B, is formed as a unitary structure comprising a body 20, a funnel 30, and a neck 40 that detachably connects the funnel 30 to the body 20. The body 20 further comprises a reservoir 22 configured to store a predetermined amount of a product that is in a liquid state, a solid state, or an oxciouses state. The amount of product able to be stored within container 10 may depend on the application of the container 10. For example, in some embodiments, container 10 may be employed by a user to transport liquids or gels on an aircraft. Thus, container 10 may be sized such that reservoir 22 can store no more than 3.4 ounces of the liquid or gel, thereby conforming to current FAA regulations regarding the amount of a liquid permitted on-board an aircraft. In other embodiments, however, container 10 may be employed to store larger amounts of fluids, or snack foods such as potato chips, pretzels, or candy. In these embodiments, therefore, container 10 may be sized such that reservoir 22 is configured to store more than 3.4 ounces.

The funnel 30 has a wide, conical mouth 32 that tapers to a narrow stem 34. In this embodiment, funnel 30 is collapsible and flexible, and thus, may be folded against the body 20 for storage. In other embodiments, however, the funnel 30 is a rigid structure, but may still be collapsed or folded against body 20. The mouth 32 of funnel 30 is wide so as to facilitate the user introducing the product into the container 10 without spilling the product. The stem 34, which opens into a channel 50 that operatively connects the funnel 30 to the reservoir 22, helps direct the product from the mouth 32 into the reservoir 22.

In this embodiment, the neck 40 is elongated and is comprised of a heat-sensitive material. Once the reservoir 22 is filled with a product, the user may employ a heat-sealing device to apply a predetermined amount of heat laterally across the neck 40. As with the peripheral edge 16, the heat creates an air-tight seal 46 that seals the product within the reservoir 22. To open container 10 and empty the product from reservoir 22, the user needs only to detach the funnel 30 away from the body 20 of container 10 at a point that is between the seal 46 and reservoir 22. With the seal 46 removed, the user can remove the product from reservoir 22 through channel 50.

For example, one way for the user to open the container is by tearing the funnel 30 away from the body 20. To facilitate opening container 10 in this manner, one embodiment of the present disclosure provides one or more serrations 42 and notches 44 on the peripheral edge 16 along both sides of neck 40. The serrations 42 and notches 44 define “tear lines” that indicate predetermined locations at which the funnel 30 may be detached from container 10. In some embodiments, the neck 40 may also be laterally perforated to allow a user to easily tear the funnel away from the body 20.

Those of ordinary skill in the art will readily appreciate, however, that the present disclosure is not limited to detaching the funnel 30 by tearing the funnel 30 away from the body 20. In other embodiments, the funnel 30 is detachably coupled to the body 20 using other means, such as clips, snaps, hook and loop fastening strips, and the like. In these cases, the funnel 30 may be detached and re-attached to the body 20, as needed or desired.

As stated above, the sheets 12, 14 are manufactured from a heat-sensitive material. Therefore, detaching the funnel 30 from the container 10 at neck 40 does not render the container 10 useless. Rather, if the user does not completely empty reservoir 22 of all the product, the user may utilize the heat-sealing device to once again apply heat to neck 40 to re-seal the remaining amount of the product in the reservoir 22.

As previously stated, the size container 10 may be manufactured to be any size needed or desired. Further, the amount of product to be contained within reservoir 22 may be determined by the intended use for container 10. However, as seen in FIG. 1B, a container 10 configured according to one embodiment of the present disclosure has the following measurements.

TABLE 1

| Description | Reference | Measurement (mm) |
|---|---|---|
| Height of Assembled Container | d₁ | 198.1 |
| Width of Body | d₂ | 98.5 |
| Height of Body | d₃ | 98.5 |
| Height of Body + Neck | d₄ | 149.8 |
| Width of Peripheral Edge (Body) | d₅ | 7.5 |
| Width of Peripheral Edge (Neck) | d₆ | 7.5 |
| Width of Peripheral Edge (Mouth | d₇ | 2.5 |
| of Funnel) | | |
| Width of Funnel Mouth | d₈ | 81.5 |
| Height of Funnel (Mouth to Stem) | d₉ | 48.3 |
| Width of Channel in Neck | d₁₀ | 15 |
| Width of Reservoir (Upper) | d₁₁ | 88.4 |
| Width of Reservoir (Middle) | d₁₂ | 73.5 |
| Width of Reservoir (Lower - | d₁₃ | 88.5 |
| taken from opposing mid-points in | | |
| Peripheral Edge) | | |

The embodiment of FIGS. 1A-1B illustrate container 10 as being constructed from separate sheets 12, 14 of heat-sensitive material. However, those of ordinary skill in the art should realize that separate sheets 12, 14 are not required to manufacture container 10. In other embodiments, container 10 is molded as a single piece. In these cases, a mold used to create the container 10 would itself be designed to form the funnel 30 and body 20 as a unitary structure such that the funnel 30 is detachably connected to the body 20.

In another embodiment, the sheets 12, 14 comprise a unitary sheet that may be formed into a gusseted pouch having a “K-Style” bottom. With these embodiments, as is well known in the art, the bottom of container 10 expands when filled with a product thereby enabling container 10 to stand and stay upright on its own. Other types of seals are also possible to enable container 10 to be a “stand-up pouch.” Such seals include, but are not limited to, a “Doyen Seal” and a “Corner Seal.”

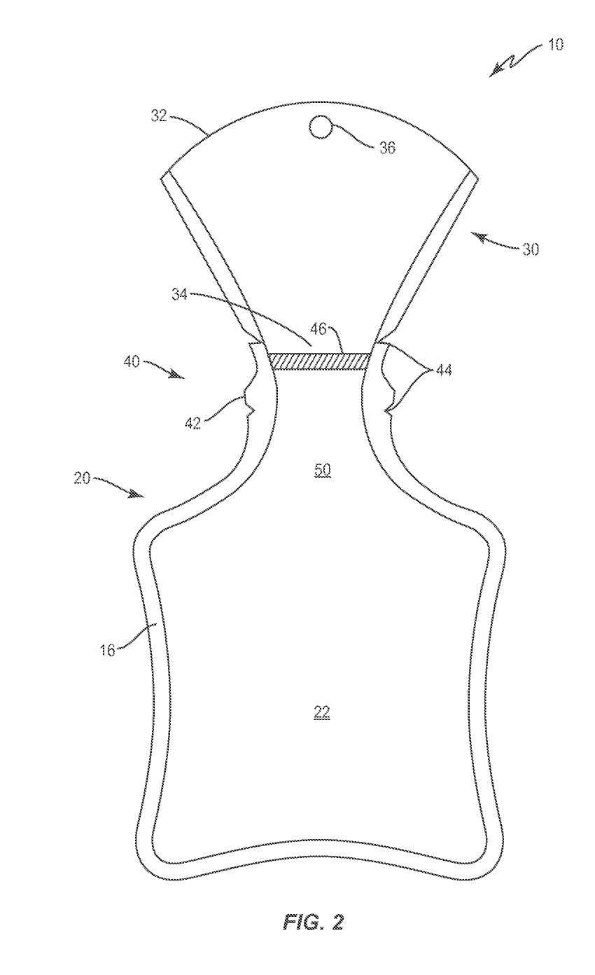

FIG. 2 illustrates another embodiment of container 10 with like reference numbers being used to indicate like components and parts. As seen in FIG. 2, neck 40 is not as elongated as the neck in FIG. 1B. However, neck 40 still retains the serrations 42 and notches 44, although they are arranged in a different manner, and is also heat-sensitive to allow the user to form one or more heat-seals 46 across its width. Additionally, the embodiment of FIG. 2 provides a through-hole 36 in the funnel 30 proximate mouth 32. Particularly, the through-hole 36 extends through both flexible sheets 12, 14, and is configured to accept a ring (e.g., a ring in a 3-ring binder) or other object that facilitates storing the container 10. Particularly, because the container 10 is flat prior to being filled with a product, the through-hole 36 provides an easy way to store and organize a plurality of containers 10. However, the through-hole 36 may still be used to store and organize a plurality of containers 10 even after they are filled with a product.

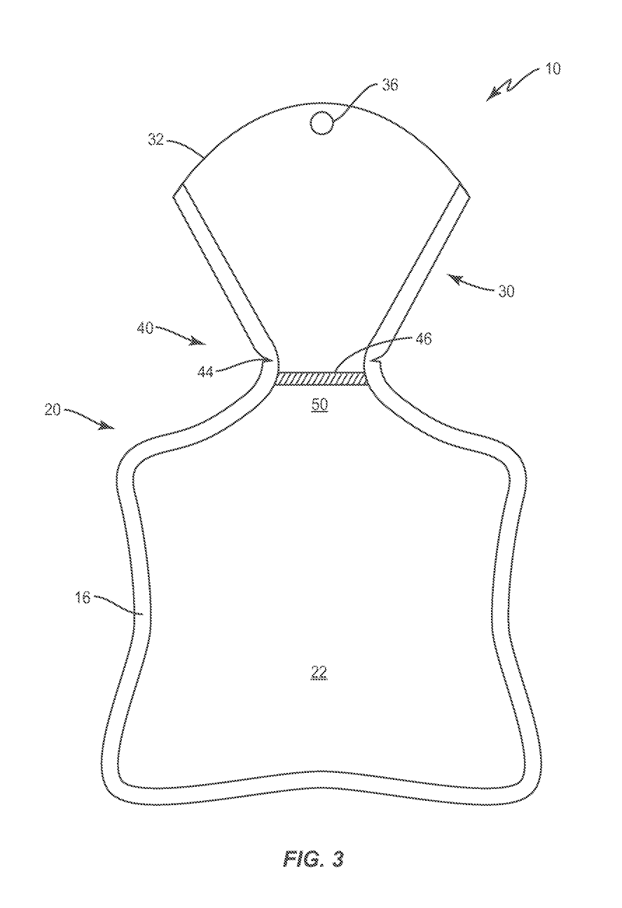

FIG. 3 illustrates another embodiment in which neck 40 comprises at least part of the stem 34 of funnel 30. As above, neck 40 is heat-sensitive to allow the user to heat-seal a product, such as a liquid, for example, in the reservoir 22. However, in these embodiments, neck 40 comprises a shortened component of container 10. Thus, the neck 40 may be formed without the serrations 42, but may still retain the one or more notches 44 to allow the user to easily tear the funnel 30 away from the body 20 to open container 10. As described in more detail below, the user may also re-use the container 10 after initially opening or unsealing container 10 by subsequently applying heat to neck 40 to form another heat-seal 46.

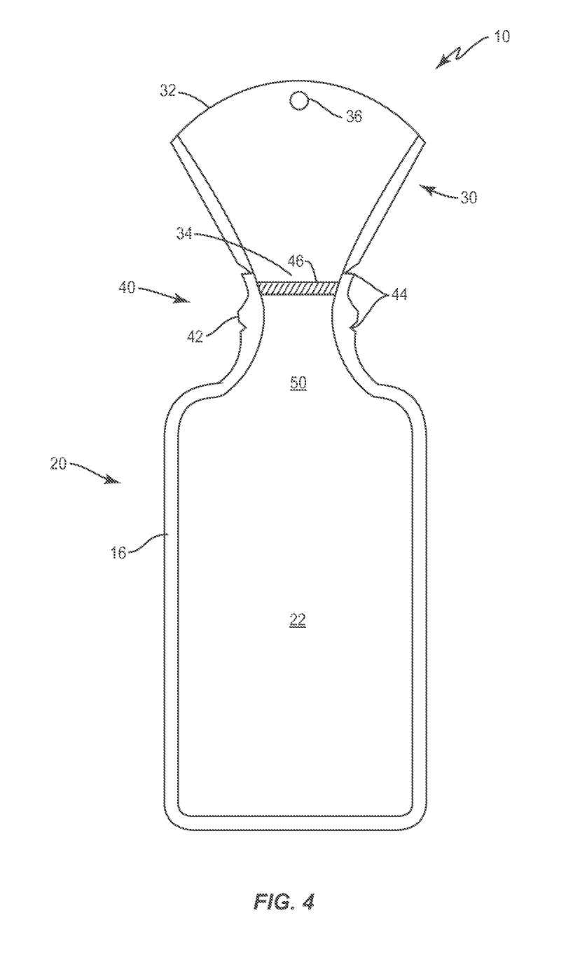

In addition to the foregoing embodiments, containers 10 may be shaped to indicate the contents within reservoir 22. For example, FIG. 4 illustrates an embodiment in which the body 20 is elongated and shaped to resemble a wine bottle. Containers 10 configured according to this embodiment may be able to store an increased amount of a product, such as wine, and may be sealed and re-sealed using heat, as previously described.

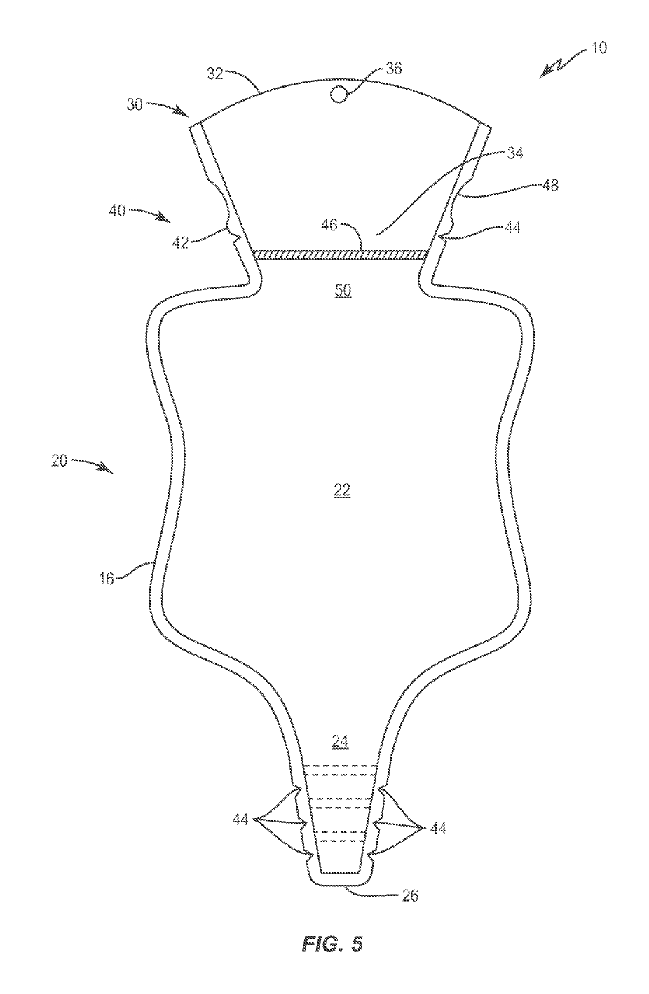

FIG. 5 illustrates another embodiment in which container 10 is configured to store and transport products such as relatively viscous liquids (e.g., mayonnaise, ketchup, shampoo, icing, etc.), and/or products in an oxciouses state (e.g., applesauce). In this embodiment, neck 40 also includes a pair of opposing scalloped areas 48 formed in the peripheral edge 16 on one or both sides of neck 40. The scalloped areas 48 may be sized and shaped to conform to the user's thumb and fingers, and may assist the user in holding the funnel 30 open when filling the container 10.

Additionally, the body 20 in the embodiment of FIG. 5 further comprises an elongated tube 24 having a tapered tip 26. With this configuration, the user may fill the reservoir 22 through funnel 30 with a relatively viscous product such as icing, mayonnaise, or ketchup, for example, and heat-seal the neck 40 as previously described. Then, to open container 10, the user may simply cut the tip 26 off of the body 20 at a desired point. Alternatively, or additionally, there may be one or more notches 44 formed along the peripheral edge of tube 24 on one or both sides. As above, each notch 44 defines a tear line along which a user may tear away the tip 26.

To extract the product, the user simply squeezes the body 20 such that the product within reservoir 22 is directed out of the container 10 through tube 24. It should be noted that, since the tube 24 is tapered, the amount of product that is expelled from the reservoir may be controlled by the user. That is, cutting or tearing the tube 24 closer to the body 20 will create a larger hole, thereby allowing more of the product within reservoir 22 to be expelled through the tube 24. Cutting or tearing the tube 24 closer to tip 46, however, will result in a narrower hole thereby restricting the flow of the product from reservoir 22.

As above, the material that is used to create the container 10 in FIG. 5 is heat-sensitive. Therefore, a user may use heat, as previously described, to re-seal the tube 24 after cutting off tip 26, seen by the dotted lines in FIG. 5. Further, as in the previous embodiments, the user may re-seal the tube section 24 multiple times to allow multiple uses of the contents of container 10 over time. That is, after initially opening container 10 by tearing away a portion of tube 24, the user may squeeze some of the contents of container 10 out through tube 24. If container 10 is not fully emptied after the initial opening, the user may apply heat to tube 24 to a selected section of tube 24 to subsequently re-seal the remaining portion of the contents in container 10 for later use.

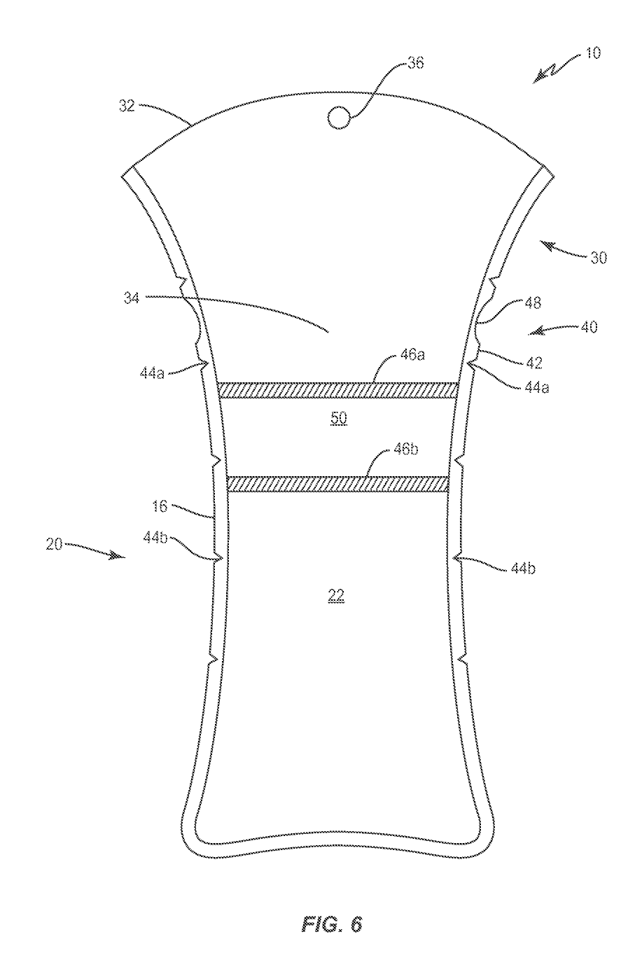

As previously stated, container 10 is not limited to storing only liquids or other relatively free-flowing products. In some embodiments, such as the embodiment seen in FIG. 6, container 10 is configured to store dry goods and other solids, such as chips, pretzels, candy, nuts, and the like. With such embodiments, the serrations 42, notches 44, and/or scalloped areas 48 that are formed in peripheral edge 16 are disposed along one or both sides of the neck 40 and body 20. Thus, after filling and heat-sealing container 10 with a solid product, a user may tear the funnel 30 away from the body 20 at a first notch 44a, as previously described, to open container 10. Then, the user may subsequently re-seal the container 10 using heat to form subsequent heat-seal 46b to retain any unused dry goods within reservoir 22. Thereafter, to re-open the container 10, the user simply tears the body 20 at a notch 44b. Thus, the container 10 of FIG. 6 is also reusable, as are the containers 10 of the previous embodiments.

In another embodiment of the present disclosure, container 10 may be formed such that the user may manually extend the funnel 30 from the body 20, and retract the funnel 30 into the body 20, as needed.

The present invention may, of course, be carried out in other ways than those specifically set forth herein without departing from essential characteristics of the invention. Therefore, the present embodiments are to be considered in all respects as illustrative and not restrictive, and all changes coming within the meaning and equivalency range of the appended claims are intended to be embraced therein.

What is claimed is:

1. A method of filling a flexible unitary container, the method comprising:
filling a container with a product, the container comprising:
a flexible body comprising a reservoir to store the product, wherein the flexible body is formed by opposing flat sheets of a heat-sensitive material sealed at a peripheral edge;
a funnel detachably connected to the flexible body configured to introduce the product into the reservoir; and
a heat-sensitive neck section detachably connecting the funnel to the flexible body, and defining a channel through which the product passes from the funnel into the reservoir;
sealing the product within the reservoir by applying heat to the heat-sensitive neck section; and
detaching the funnel from the flexible body.

2. The method of claim 1 further comprising:
unsealing the container to remove at least a portion of the product from the reservoir; and
resealing the container to reseal a remaining portion of the product within the reservoir by re-applying heat to the heat-sensitive neck section.

3. The method of claim 1 wherein the heat-sensitive neck section comprises one or more tear indicators disposed along the peripheral edge of the heat-sensitive neck section, each tear indicator defining a tear line for detaching the funnel.

4. The method of claim 3 wherein detaching the funnel from the flexible body comprises tearing the funnel away from the flexible body at a selected tear indicator.

5. A container comprising:
a reservoir configured to store a product;
a detachable funnel;
a channel communicatively connecting the funnel to the reservoir; and
a heat-sensitive neck section disposed between the detachable funnel and the reservoir, and configured to be heat-sealed to seal the product within the reservoir.

6. The container of claim 5 wherein the container comprises a unitary structure formed by first and second flat flexible sheets sealed at peripheral edges.

7. The container of claim 5 wherein the reservoir is configured to expand to store a product that is in one of a liquid state, a solid state, and an oxciouses state.

8. The container of claim 5 wherein the heat-sensitive neck section forms at least a part of the channel.

9. The container of claim 8 wherein the channel comprises a passage through which the product passes from the detachable funnel into the reservoir.

10. The container of claim 8 further comprising one or more indicators disposed along a peripheral edge of the heat-sensitive neck section, each indicator defining a tear line along the heat-sensitive neck section for detaching the funnel from the container.

11. The container of claim 10 wherein the one or more indicators comprise one or more serrations.

12. The container of claim 10 wherein the one or more indicators comprise one or more notches.

13. The container of claim 5 further comprising a through-hole formed in each of the first and second flat flexible sheets proximate a mouth of the detachable funnel.

14. The container of claim 5 wherein the heat-sensitive neck section is further configured to be unsealed to remove at least a portion of the product from the reservoir, and subsequently resealed to seal at least a remaining portion of the product within the reservoir.

15. The container of claim 5 wherein each of the first and second flat flexible sheets are comprised of a food-grade material.

16. The container of claim 5 further comprising a tube formed at one end of the container configured to direct the product out of the reservoir.

17. A container comprising:
a unitary structure comprised of opposing flat sheets of a heat-sensitive material sealed at a peripheral edge and forming:
a flexible body comprising a reservoir to store a product;
a funnel detachably connected to the flexible body and configured to introduce the product into the reservoir;
a heat-sensitive neck section detachably connecting the funnel to the flexible body, and defining a channel through which the product passes from the funnel into the reservoir; and
wherein the heat-sensitive neck section is configured to be heat-sealed at multiple locations to seal and reseal the product within the reservoir.

18. The container of claim 17 wherein the heat-sealing neck section is configured to be resealed after the funnel has been detached from the flexible body.

19. The container of claim 17 wherein the heat-sensitive neck section forms at least a part of the channel.

20. The container of claim 17 further comprising one or more tear indicators formed along the peripheral edge proximate the heat-sensitive neck section, each tear indicator defining a tear line for detaching the funnel from the container.
